(19) United States
(12) Patent Application Publication
(10) Pub. No.: US 2007/0168689 A1
(43) Pub. Date: Jul. 19, 2007

(54) Device and method for recording information with remapping of logical addresses to physical addresses when defects occur

(75) Inventors: Johannis Friso Rendert Blacquiere, Eindhoven (NL); Pope Ijtsma, Eindhoven (NL); Dirk Hamelinck, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/561,466

(22) PCT Filed: Jun. 17, 2004
(86) PCT No.: PCT/IB04/50929

§ 371 Date: Dec. 20, 2005

(30) Foreign Application Priority Data
Jun. 23, 2003 (EP) 03101836.9

(51) Int. Cl. G06F 11/00

(52) U.S. Cl. 714/4

(57) ABSTRACT

A device for recording records information in blocks having logical addresses at a physical address (52) in a track on a record carrier. The logical addresses are translated into the physical addresses in dependence of defect management information, such as remapping tables, maintained in defect management areas. For avoiding remapping of real time information, such as video, a series of blocks (42) having a continuous logical address range is recorded in a corresponding allocated physical address range. In the event of a defect interrupting the allocated physical address range local offset information is generated for adding an offset to a local range of physical addresses in said address translation for skipping (61) the defect. The blocks logically following the last block before the defect are written at physical addresses following the defect, and an end portion (62) that extends beyond the allocated physical address range due to the defect, is accommodated elsewhere.

The invention relates to a device for recording information.

The invention further relates to a device for reading information.

The invention further relates to a method of recording of information.

The invention further relates to a computer program product for recording of information.

The invention relates to the field of defect management in recording systems, and in particular to defect management when continuously recording real-time information such as video.

A device and method for recording information on a record carrier are known from WO 01/06512, in which digitally compressed video data is recorded on an optical disc according to a video encoding standard, for example the MPEG2 format. The apparatus has input means for receiving video information, and recording means for recording the video information in a stream of information blocks having a continuous logical address range in the track at an allocated physical address range. The logical addresses constitute a contiguous storage space. In practice, the record carrier may exhibit defective parts of the track, in particular a defect preventing a block to be recorded at a specific physical address. These defects might be caused by scratches, dust, fingerprints and so on. Logical addresses assigned to defective physical addresses are remapped to different physical addresses in a defect management area. Remapping introduces a performance penalty as this remapping introduces a movement of the optical head (OPU), and possibly also a medium rotational speed adjustment and rotational delay(s). To prevent frequent jumps it is proposed to not only remap the defective physical address but to remap a larger portion of the video file to a free area in the user data zone on the record carrier. An allocation manager which is part of the file system is informed to update actual logical addresses used for storing the video file. A problem of the known system is that for each error in the physical address range a jump to a free area is required. In particular a number of relatively small errors results in storing the video stream in a number of jumps to remotely located free areas.

It is an object of the invention to provide a system for recording and reproducing information blocks having a continuous logical address range on related physical addresses, while obviating the amount of jumps to remote physical addresses.

For this purpose in accordance with a first aspect of the invention the device for recording information in blocks having logical addresses on a record carrier comprises recording means for recording marks in a track on the record carrier representing the information, control means for controlling the recording by locating each block at a physical address in the track, the control means comprising addressing means for translating the logical addresses into the physical addresses and vice versa in dependence of defect management information, defect management means for detecting defects and maintaining the defect management information in defect management areas on the record carrier, the defect management information at least including remapping information indicative for translating a logical address initially mapped to a physical address exhibiting a defect to an alternate physical address in a defect management area, contiguous recording detection means for detecting a series of blocks having a continuous logical address range to be recorded in a corresponding allocated physical address range, offset means for generating local offset information for, in the event of a defect interrupting the allocated physical address range, adding an offset to a local range of physical addresses in said address translation for skipping the defect and writing the blocks logically following the last block before the defect at physical addresses following the defect, and end portion recording means for accommodating recording an end portion of at least one block of the continuous logical address range, which end portion extends beyond the allocated physical address range due to the defect.

For this purpose in accordance with a second aspect of the invention a device for reading information in blocks on a record carrier comprises reading means for reading marks in a track on the record carrier representing the information, control means for controlling the reading by locating each block at a physical address in the track, the control means comprising addressing means for translating physical addresses into logical addresses and vice versa in dependence of defect management information, the defect management information at least including remapping information indicative for translating a logical address initially mapped to a physical address exhibiting a defect to an alternate physical address in a defect management area, and offset means for recovering local offset information for adding an offset to a local range of physical addresses in said address translation for skipping a defect.

For this purpose in accordance with further aspects of the invention a method and computer program product for recording and/or reading are given in the claims.

The measures according to the invention have the advantage that defects, once detected, are locally skipped and the series of information blocks interrupted by the defect is continued immediately after the defect. Hence for local defects no jumps to defect management areas are required, whereas the end portion is formed by the number of blocks that are skipped due to defects. Local offset information is generated indicating a local reassignment of physical addresses. The end portion is accommodated in an alternative physical location requiring at most a single jump.

The invention is also based on the following recognition. Initial defects on a record carrier may be detected during formatting and may be registered in a primary defect list, which results in skipping the defects, and reassigning all logical addresses following a defect, for example as described in US 2001/0002488. Hence the primary defect list cannot be updated after writing user data because the assignment of logical to physical addresses would change. However scanning a record carrier during formatting is time consuming and therefore often omitted, and defects will result in remapping. During recording the usual defect management systems heavily rely on remapping defect physical addresses to defect management areas. The inventors have seen that remapping can be avoided or at least reduced by adapting the write process. In particular the frequent jumps resulting from remapping small defect can be avoided. For that purpose the inventors have included the local offset information for locally skipping the defects and finally accommodating recording the end portion.

In an embodiment of the device the end portion recording means are for recording the end portion in a defect management area, in particular in a single defect management area. This has the advantage that only a single substantial jump is required for retrieving the series of blocks.

In an embodiment of the device the end portion recording means are for remapping a number of blocks following the allocated physical address range, the number corresponding to the number of blocks in the end portion, and for recording the end portion starting at the physical address following the allocated physical address range. This has the advantage that no substantial jump is required for retrieving the series of blocks, whereas in the event that the remapped number of blocks is part of a different series of blocks a jump may be needed for retrieving the different series.

Further embodiments are given in the dependent claims.

These and other aspects of the invention will be apparent from and elucidated further with reference to the embodiments described by way of example in the following description and with reference to the accompanying drawings, in which

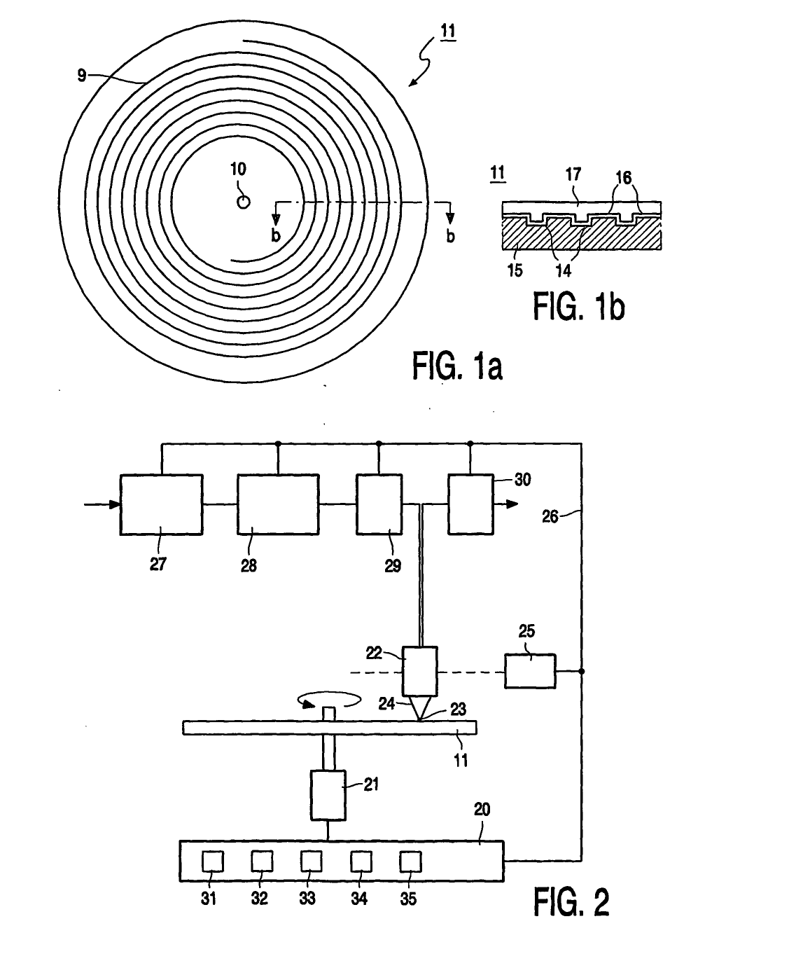

FIG. 1a shows a record carrier (top view),

FIG. 1b shows a record carrier (cross section),

FIG. 2 shows a recording device,

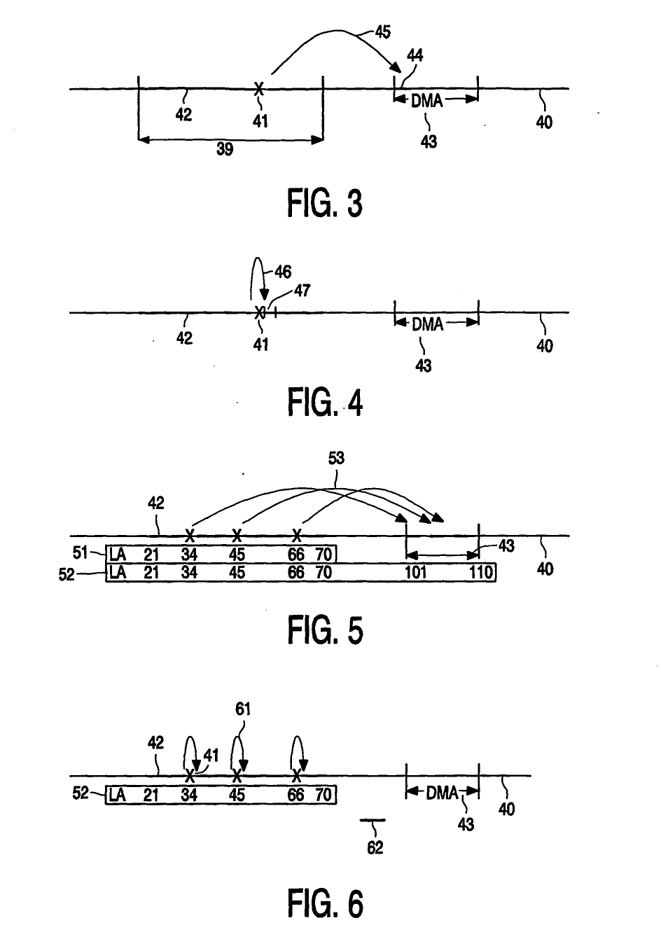

FIG. 3 shows remapping of defective locations,

FIG. 4 shows locally skipping a defect,

FIG. 5 shows conventional remapping for a number of defects,

FIG. 6 shows contiguous recording avoiding remapping, and

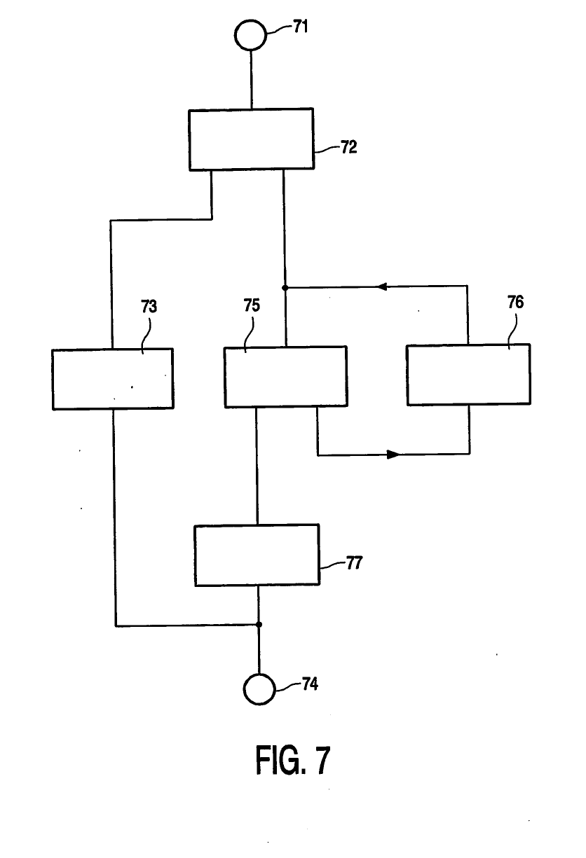

FIG. 7 shows a method for contiguous recording.

Corresponding elements in different Figures have identical reference numerals.

FIG. 1a shows a disc-shaped record carrier 11 having a track 9 and a central hole 10. The track 9, being the position of the series of (to be) recorded marks representing information, is arranged in accordance with a spiral pattern of turns constituting substantially parallel tracks on an information layer. The record carrier may be optically readable, called an optical disc, and has an information layer of a recordable type. Examples of a recordable disc are the CD-R and CD-RW, and writable versions of DVD, such as DVD+RW, and the high density writable optical disc using blue lasers, called Blu-ray Disc (BD). Further details about the DVD disc can be found in reference: ECMA-267: 120 mm DVD—Read-Only Disc—(1997). The information is represented on the information layer by recording optically detectable marks along the track, e.g. crystalline or amorphous marks in phase change material. The track 9 on the recordable type of record carrier is indicated by a pre-embossed track structure provided during manufacture of the blank record carrier. The track structure is constituted, for example, by a pregroove 14 which enables a read/write head to follow the track during scanning. The track structure comprises position information including so-called physical addresses, for indicating the location of units of information, usually called information blocks. The position information includes specific synchronizing marks for locating the start of such information blocks.

FIG. 1b is a cross-section taken along the line b-b of the record carrier 11 of the recordable type, in which a transparent substrate 15 is provided with a recording layer 16 and a protective layer 17. The protective layer 17 may comprise a further substrate layer, for example as in DVD where the recording layer is at a 0.6 mm substrate and a further substrate of 0.6 mm is bonded to the back side thereof. The pregroove 14 may be implemented as an indentation or an elevation of the substrate 15 material, or as a material property deviating from its surroundings.

The record carrier 11 is intended for carrying digital information in blocks under control of a file management system, the information including real-time information to be recorded and reproduced continuously, in particular information representing digitally encoded video according to a standardized format like MPEG2.

FIG. 2 shows a recording device for writing information on a record carrier 11 of a type which is writable or re-writable, for example CD-R or CD-RW, or DVD+RW or BD. The device is provided with recording means for scanning the track on the record carrier which means include a drive unit 21 for rotating the record carrier 11, a head 22, a positioning unit 25 for coarsely positioning the head 22 in the radial direction on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises (not shown) a focusing actuator for moving the focus of the radiation beam 24 along the optical axis of said beam and a tracking actuator for fine positioning the spot 23 in a radial direction on the center of the track. The tracking actuator may comprise coils for radially moving an optical element or may alternatively be arranged for changing the angle of a reflecting element For writing information the radiation is controlled to create optically detectable marks in the recording layer. The marks may be in any optically readable form, e.g. in the form of areas with a reflection coefficient different from their surroundings, obtained when recording in materials such as dye, alloy or phase change material, or in the form of areas with a direction of magnetization different from their surroundings, obtained when recording in magneto-optical material. For reading the radiation reflected by the information layer is detected by a detector of a usual type, e.g. a four-quadrant diode, in the head 22 for generating a read signal and further detector signals including a tracking error and a focusing error signal for controlling said tracking and focusing actuators. The read signal is processed by read processing unit 30 of a usual type including a demodulator, deformatter and output unit to retrieve the information. Hence retrieving means for reading information include the drive unit 21, the head 22, the positioning unit 25 and the read processing unit 30. The device comprises write processing means for processing the input information to generate a write signal to drive the head 22, which means comprise an input unit 27, and modulator means comprising a formatter 28 and a modulator 29. During the writing operation, marks representing the information are formed on the record carrier. The marks are formed by means of the spot 23 generated on the recording layer via the beam 24 of electromagnetic radiation, usually from a laser diode. Writing and reading of information for recording on optical disks and formatting, error correcting and channel coding rules are well-known in the art, e.g. from the CD and DVD system.

The control unit 20 is connected via control lines 26, e.g. a system bus, to said input unit 27, formatter 28 and modulator 29, to the read processing unit 30, and to the drive unit 21, and the positioning unit 25. The control unit 20 comprises control circuitry, for example a microprocessor, a program memory and control gates, for performing the procedures and functions according to the invention as described below. The control unit 20 may also be implemented as a state machine in logic circuits. The control unit 20 controls the recording and retrieving of information and may be arranged for receiving commands from a user or from a host computer.

The input unit 27 processes the audio and/or video to units of information, which are passed to the formatter 28 for adding control data and formatting the data as information blocks according to a predefined recording format, e.g. by adding error correction codes (ECC) and/or interleaving. For computer applications units of information may be interfaced to the formatter 28 directly. The formatted data from the output of the formatter 28 is passed to the modulation unit 29, which comprises for example a channel coder, for generating a modulated signal which drives the head 22. Further the modulation unit 29 comprises synchronizing means for including synchronizing patterns in the modulated signal. The formatted units presented to the input of the modulation unit 29 comprise address information and are written to corresponding addressable locations on the record carrier under the control of control unit 20, and for performing defect management as described below.

In an embodiment the input unit 27 is arranged for receiving real-time information. The input unit may comprise compression means for input signals such as analog audio and/or video, or digital uncompressed audio/video. Suitable compression means are described for audio in WO 98/16014-A1 (PHN 16452), and for video in the MPEG2 standard. The input signal may alternatively be already digitally encoded.

The control unit 20 is arranged for controlling the recording by locating each block at a physical address in the track, and includes the following cooperating functional units: an addressing unit 31, a defect management unit 32, a contiguous recording detection unit 33, an offset unit 34, and an end portion recording unit 35.

The addressing unit 31 is for translating physical addresses into logical addresses and vice versa in dependence of defect management information. The logical addresses constitute a contiguous storage space to be used for storing files of information blocks under control of a file management system, for example UDF. The defect management unit 32 detects defects, for example by monitoring the signal quality of a read-out signal from the head 22 during recording and/or reading. The defects may also be detected by determining an error rate in retrieved information blocks. The defect management unit further maintains the defect management information in defect management areas on the record carrier, for example in defect lists as defined for the DVD recordable systems like DVD+RW or the Mount Rainier defect management as defined for CD-MRW. A description of Mount Rainier and CD-MRW is available from Philips on http://www.licensing.philips.com/information/mtr/. The defect management information at least includes remapping information.

In an embodiment the recording device is arranged as a drive unit to be connected to a separate host system, for example a drive unit to be build in a PC. The control unit 20 is arranged to communicate with a processing unit in the host system via a standardized interface. Alternatively the recording drive is arranged as a stand alone unit, for example a video recording apparatus for consumer use. The control unit 20, or an additional host control unit included in the device, is arranged to be controlled directly by the user, and to also perform the functions of the file management system.

FIG. 3 shows remapping of defective locations. A physical address space 40 is schematically represented by a horizontal line. A series of blocks 42 is to be recorded in an allocated physical address range 39. However a defect 41 interrupts the allocated physical address range. Remapping 45 is the process that a block 44 having a logical address corresponding to the physical address 41 that is defective is stored in an alternative physical address in a defect management area (DMA) 43. The remapping information provides data for translating the logical address initially mapped to a physical address exhibiting a defect to an alternate physical address in a defect management area, for example an entry in a secondary defect list including the logical address of the remapped block and its corresponding physical address. Alternatively remapping information may include data for translation of a physical address of a defect to a different physical address in a defect management area.

The contiguous recording detection unit 33 in FIG. 2 is for detecting a series of blocks having a continuous logical address range to be recorded in a corresponding allocated physical address range. In general contiguous recording is required for real-time information which has a relative high data rate, in particular video information. The type of data may be included in the writing commands received by the control unit, for example a write command from a host computer including a real-time bit. The detection of contiguous recording may also be based on the amount of data blocks indicated in a write command, or by other aspects such as the fact that new blocks having logical addresses consecutive to the last written block arrive at regular intervals.

FIG. 4 shows locally skipping a defect. Similar to FIG. 3 a series of blocks 42 is to be recorded in an allocated physical address range. However a defect 41 interrupts the allocated physical address range. Instead of remapping the block 47 having a logical address corresponding to the physical address 41 that is defective, the block 47 is stored immediately following the defect 41. Further blocks of the series are stored consecutively thereafter. Effectively the defect is skipped as indicated by arrow 46.

The offset unit 34 in FIG. 2 is for generating local offset information, which local offset information indicates that logical addresses after a defect have to be translated to physical addresses by including the offset. The local offset information is included in the defect management information. First it is detected that a defect interrupts the allocated physical address range of a series of blocks having a continuous logical address range, as shown in FIG. 4. If so, the offset information indicates that the offset to be added to a local range of physical addresses in said address translation for skipping the defect and writing the blocks logically following the last block before the defect at physical addresses following the defect. It is noted that, due to the defect, at the end of the series of blocks a number of blocks called the end portion will exceed the allocated physical address range. The end portion recording unit 35 is for accommodating recording the end portion. Several options are given below for recording the end portion.

A device for reading information that has been recorded according to the invention has the same elements as the recording device described above, except the recording elements such as the input unit 27, formatter 28, modulator 29, the contiguous recording detection unit 33 and the end portion recording unit 35. The defect management means 32 are arranged for retrieving the defect management information, whereas the offset means 34 are arranged for retrieving the local offset information and applying the local offset to the translation of addresses in the addressing unit 31.

FIG. 5 shows conventional remapping for a number of defects. Similar to FIG. 3 a series of blocks 42 is to be recorded in an allocated physical address range. Logical addresses 51 and physical addresses 52 are given below the horizontal line 40 indicating the physical address space. In the examples it is assumed that no primary defects exist before the current physical addresses, and that therefore the logical address are initially equal to the physical addresses. For example medium defects at physical addresses PA34, PA45 and PA66 were detected earlier, e.g. when the present data on that range was written. The defects are remapped, as shown by arrows 53, to physical addresses between PA101 and PA110, which are assigned to the DMA 43. Note that normally remapping is performed in complete ECC units containing a number of blocks, but for the examples only single blocks are assumed to be defective and remapped.

FIG. 6 shows contiguous recording avoiding remapping. Similar to FIG. 5 a series of blocks 42 is to be recorded in an allocated physical address range. The same defects are known, either remapped earlier or detected during the present write action. It is assumed that a host system wants to write the series of blocks 42 to an allocated physical address range that contains the multiple (three in the example) errors. In the write process no remapping is used, which is possible by using one of the various solutions listed below.

The host wants to write data to the logical block address range from logical address LA21 towards logical address LA70. In this area during previous usage three errors where detected. These errors are located on position PA34, PA45 and PA66. To write the 50 logical blocks to the medium without remapping, the solution is to jump over the defects as indicated by arrows 61. That means however that at the end of the logical area that was assigned for the data there are three blocks remaining due to the skipped defects. The remaining blocks are shown as end portion 62 in FIG. 6. In other words, of the data of 50 blocks that has to be written to disc only blocks 1 until 47 are written on in the physical blocks address range 21 until 70. In the various solutions below it is indicated how to record the end portion (the three remaining blocks 48 to 50) on disc as well.

A first solution is to write the end portion 62 in the DMA and update the remapping information accordingly. The offset unit generates a ‘From-Offset’ table or a ‘From-Offset’ entry in a defect table. This table or entry informs the drive of an offset in the logical to physical mapping. In this example the table (or entries) would look like below:

| From logical address | Offset |
|---|---|
| 34 | 1 |
| 44 | 2 |
| 64 | 3 |
| 68 | 33 |
| 71 | 0 |

The advantage of this solution is that instead of three additional jumps forward and back (in total around six additional jumps) only one jump forward (plus three very small jumps over the defects that hardly require any time) is required now, to retrieve all 50 data blocks.

A second solution is to write the end portion on physical addresses 71, 72 and 73. The data that might be present on the physical addresses 71, 72 and 73 is replaced in to the DMA. For that data the same solutions can be implemented as described in the first solution above for the end portion. The offset unit generates a ‘From-Offset’ table or a ‘From-Offset’ entry in the defect table as follows:

| From logical address | Offset |
|---|---|
| 34 | 1 |
| 44 | 2 |
| 64 | 3 |
| 71 | 30 |
| 74 | 0 |

The advantage of the second solution is that it is now possible to read all 50 blocks without additional jumps (apart from the three very small jumps over the defects).

A third solution is to ‘shift’ all data from the physical address range 71 until 100 three blocks forward. This means that the logical address 68 is written on physical address 71, logical address 69 on 72 and so on until logical address 100, which is written at physical address 103. The shifting involves potentially quite a lot of data (all data blocks up until the next DMA). The effect of the shifting is that the DMA is made effectively three blocks smaller (normally these 3 blocks would have been used for the remapping of the defects). The ‘From-Offset’ table would look like:

| From logical address | Offset |
|---|---|
| 34 | 1 |
| 44 | 2 |
| 64 | 3 |
| 101 | 0 |

Effectively a piece out of the DMA is used. When there are already spares on the location 101-103 these have to be shifted to another location in the DMA and the defect tables will have to be updated accordingly.

In an embodiment entries are created in the defect tables for each ‘remapped’ block. This can be done by indicating all separate addresses with their remapped value, but this has the disadvantage that the remapping table becomes quite big.

| From logical address | To Physical address |
|---|---|
| 35 | 36 |
| 36 | 37 |
| 37 | 38 |

. . .

The advantage of this solution is that both the data written at the physical locations 21-72 and 73-103 are written substantially contiguously on disc. This means that reading both data areas can be retrieved without requiring additional jumps (apart from the three small jumps over the defects). The disadvantage is of course that it requires potentially a lot shifting of data over the disc. This could be done in the background to minimize the effects for the user.

In an embodiment the offset unit is arranged for adapting a defect management table indicating initial defects, usually called the primary defect list (PDL). The translation of logical into physical addresses is corrected using the number of initial defects in the PDL. The offset unit includes a new entry in the PDL for a defect detected later. It is noted that the effect of changing the PDL after the initial formatting of the record carrier affects the logical to physical translation of all higher physical addresses (beyond the new entry). Hence any previously written data blocks at the higher physical addresses need to be moved, which is only practical if the number of previously written blocks is small or zero. Further it is noted that the size of the user data area is reduced by such additions to the PDL. For recovering the lost user data area a local offset entry is included indicating that the logical addresses missing at the end of the user data area covered by the PDL are remapped in a suitable defect management area, for example a relatively large defect management area immediately following the end of the user data area.

In a fourth solution the end portion is written at an arbitrary free location on disc. To be able to determine which data areas are free the drive has to have file system knowledge or a negotiation scheme with the host is required. It is beneficial to write the three remaining blocks in a free area that is (physically) close to minimize the jump distance and thereby the additional access penalty. For example the three data blocks are written on the physical locations 131, 132 and 133. After the data has been written the defect tables are updated. This updating encompasses the following:
Logical address 68 is remapped towards physical address 131, LA 69 towards PA132 and LA70 towards PA133. The logical blocks (121, 122 and 123) that where originally assigned to physical addresses 131-133 can be remapped in two ways.
   1. The logical blocks are remapped towards physical blocks 34, 45 and 66. This makes them effectively useless.
   2. The logical blocks are remapped to a DMA, which makes them still usable. It is noted that contiguous recording across such remapped logical blocks is not easily possible.

In a fifth solution file system knowledge in the drive is required or an interaction scheme with the host that results in the drive having access to the file system knowledge. In this solution the host gives again the write order to write the 50 data blocks again to the logical data address range 21-70. The drive does not use the remapped logical blocks but writes the end portion at another free location in the user area (logical space). After the data has been written the drive updates the file system to reflect that the data is not written in the logical range 21-70, but instead of that multiple extents have been created. Suppose that the three remaining blocks are written at logical addresses 120, 121 and 122. In that case the drive creates five file extents for the data blocks. These extents occupy the following logical areas:
1. 21-33
2. 35-44
3. 46-65
4. 67-70
5. 120-122
   It is to be noted that the drive decides to write the data on different logical addresses, and informs host running the file management system later. Updating the file system can't just be done by the drive without the risk of the host getting confused. Thereto the drive initiates an ‘unmount-mount’ procedure. This is required to update the file system information that is present in the host, e.g. initially retrieved from the record carrier and stored in host memory, to avoid any discrepancy between the file system information in the host and the situation on the medium. Until this moment writing to or reading from the medium should actually be avoided. In an embodiment successive write actions are performed before the unmount-mount procedure by temporarily remapping the logical blocks that were originally assigned to physical blocks 130-132.

A further solution is based on the fifth solution above. Instead of writing the three remaining blocks at another location, the blocks that were written on physical blocks 71-73 are written somewhere else. This requires reading these blocks into cache and storing them for a short period of time. After the 50 data blocks are written, the data temporarily stored in the cache has to be written to the medium. After that the file system information has to be updated. This is the same as described above with the fifth solution.

In alternatives to the above embodiments, instead of generation a From Offset table, ranges and defects are indicated in a table. In a range the drive should use the ‘slipping’ calculation for the physical addresses. This effectively means that the drive calculates the From-Offset information itself.

In general it is noted that removing (Part of) a DMA from the available total defect management area is a possibility to create some free space (for the drive or user data area) at a desired location at a medium. If it has to be accessible for the user updating of the logical address space is required.

FIG. 7 shows a method for contiguous recording. The method for recording information in blocks having logical addresses on a record carrier controls the recording by locating each block at a physical address in the track. The logical addresses are translated into physical addresses and vice versa in dependence of defect management information. The logical addresses constituting a contiguous storage space. The defect management information at least includes remapping information indicative for translating a logical address initially mapped to a physical address exhibiting a defect to an alternate physical address in a defect management area. For the translation defect management information is retrieved from the record carrier, for example primary defect lists indicating slipped defects as described above. It is noted that the defect management information includes remapping information indicative for translating a logical address initially mapped to a physical address exhibiting a defect to an alternate physical address in a defect management area. The process of translating addresses, detecting defects and maintaining the defect management information in the defect management areas is not shown separately in the Figure.

In a first step 71 ‘RECEIVE’ a command is received to record a series of blocks having continuous logical addresses, in particular digitally encoded video. In a step ‘DETECT’ 72 it is detected if continuous recording of a series of blocks is required to be recorded in a corresponding allocated physical address range, e.g. by detecting if the series of blocks has a continuous logical address range of a substantial size, or by detecting a predetermined ‘real-time’ bit in the write command. If no contiguous recording is needed, the blocks are written and defect management information for remapping is accumulated and stored in a conventional step ‘REMAP’ 73. After writing the last block the recording is complete at ‘END’ 74.

If contiguous recording is detected blocks are written until a defect is detected that interrupts the allocated physical address range in ‘WRITE-DETECT’ step 75. In the event of a defect interrupting the allocated physical address range, local offset information is generated in an ‘OFFSET’ step 76 for adding an offset to a local range of physical addresses in said address translation. Effectively the defect is skipped by continuing writing the blocks logically following the last block before the defect at physical addresses following the defect until the last physical address of the allocated range is written. Due to the skipped defects some last blocks of the continuous logical address range, called the end portion, are not yet written. In an ‘END PORTION’ step 77 the end portion is accommodated elsewhere on the record carrier, as described above with FIG. 6.

Although the invention has been explained mainly by embodiments using the CD, similar embodiments like DVD or BD having defect management can apply the invention. Also for the information carrier an optical disc has been described, but other media such as a hard disc can be used. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ may be represented by the same item of hardware. Further, the scope of the invention is not limited to the embodiments, and the invention lies in each and every novel feature or combination of features described above.

1. Device for recording information in blocks having logical addresses on a record carrier, which device comprises
recording means (22) for recording marks in a track on the record carrier representing the information,
control means (20) for controlling the recording by locating each block at a physical address in the track, the control means comprising
addressing means (31) for translating the logical addresses into the physical addresses and vice versa in dependence of defect management information,
defect management means (32) for detecting defects and maintaining the defect management information in defect management areas on the record carrier, the defect management information at least including remapping information indicative for translating a logical address initially mapped to a physical address exhibiting a defect to an alternate physical address in a defect management area,
contiguous recording detection means (33) for detecting a series of blocks having a continuous logical address range to be recorded in a corresponding allocated physical address range,
offset means (34) for generating local offset information for, in the event of a defect interrupting the allocated physical address range, adding an offset to a local range of physical addresses in said address translation for skipping the defect and writing the blocks logically following the last block before the defect at physical addresses following the defect, and
end portion recording means (35) for accommodating recording an end portion of at least one block of the continuous logical address range, which end portion extends beyond the allocated physical address range due to the defect.

2. Device as claimed in claim 1, wherein the end portion recording means (35) are for recording the end portion in a defect management area, in particular in a single defect management area.

3. Device as claimed in claim 1, wherein the end portion recording means (35) are for remapping a number of blocks following the allocated physical address range, the number corresponding to the number of blocks in the end portion, and for recording the end portion starting at the physical address following the allocated physical address range.

4. Device as claimed in claim 1, wherein the end portion recording means (35) are for retrieving all previously recorded blocks in a physical address range from the physical address following the allocated physical address range up to a defect management area, for recording the end portion starting at the physical address following the allocated physical address range, and for recording said retrieved previously recorded blocks starting at the physical address following the recorded end portion.

5. Device as claimed in claim 1, wherein the offset means (34) are for generating at least one offset entry, the offset entry indicating a logical ‘from’ address and an offset to be added to a physical address for logical addresses equal to or above the logical ‘from’ address, in particular up to a next logical ‘from’ address in a next offset entry.

6. Device as claimed in claim 1, wherein the offset means (34) are for generating an entry in the remapping information for a logical address that has been reassigned to a different physical address by the end portion recording means.

7. Device as claimed in claim 1, wherein the end portion recording means (35) are for detecting a free location on the record carrier, for recording the end portion in the free location, and for remapping original logical addresses assigned to the free location, in particular remapping an original logical address to the physical address of the defect interrupting the allocated physical address range.

8. Device as claimed in claim 1, wherein the end portion recording means (35) are for detecting a free location on the record carrier, for recording the end portion in the free location, and for updating file system information indicating the logical addresses of the series of blocks as part of a file.

9. Device as claimed in claim 1, wherein the end portion recording means (35) are for detecting a free location on the record carrier,
for retrieving previously recorded blocks in a physical address range following the allocated physical address range,
for recording the end portion in the physical address range following the allocated physical address range,
for recording said retrieved previously recorded blocks in the free location, and for updating file system information indicating the logical addresses of said retrieved previously recorded blocks as part of a file.

10. Device as claimed in claim 1, wherein the contiguous recording detection means (33) are for detecting a continuous recordings indicator in a recording command, or for detecting the series of blocks representing real-time information, in particular video information.

11. Device for reading information in blocks having logical addresses on a record carrier, which device comprises
reading means (30) for reading marks in a track on the record carrier representing the information,
control means (20) for controlling the reading by locating each block at a physical address in the track, the control means comprising
addressing means (31) for translating the physical addresses into the logical addresses and vice versa in dependence of defect management information, the defect management information at least including remapping information indicative for translating a logical address initially mapped to a physical address exhibiting a defect to an alternate physical address in a defect management area, and
offset means (34) for recovering local offset information for adding an offset to a local range of physical addresses in said address translation for skipping a defect.

12. Method of recording of information in blocks having logical addresses located at a physical address in a track on a record carrier,
the logical addresses corresponding to physical addresses in dependence of defect management information,
the logical addresses constituting a contiguous storage space,
defects being detected and the defect management information being maintained in defect management areas on the record carrier, and
the defect management information at least including remapping information indicative for translating a logical address initially mapped to a physical address exhibiting a defect to an alternate physical address in a defect management area,
the method comprising
detecting continuous recording of a series of blocks having a continuous logical address range to be recorded in a corresponding allocated physical address range,
generating local offset information for, in the event of a defect interrupting the allocated physical address range, adding an offset to a local range of physical addresses in said address translation for skipping the defect and writing the blocks logically following the last block before the defect at physical addresses following the defect, and
accommodating recording an end portion of at least one block of the continuous logical address range, which end portion extends beyond the allocated physical address range due to the defect.

13. Computer program product for recording of information, which program is operative to cause a processor to perform the method as claimed in claim 12.
